(19) United States
(12) Patent Application Publication
(10) Pub. No.: US 2011/0231037 A1
(43) Pub. Date: Sep. 22, 2011

(54) HARD-LANDING OCCURRENCE DETERMINATION SYSTEM AND METHOD FOR AIRCRAFT

(75) Inventors: Ion Stiharu, Kirkland (CA); Ramin Sedaghati, Brossard (CA); Arash Firoozrai, Westmount (CA)

(73) Assignee: VALORBEC SOCIETE EN COMMANDITE, Montreal, QC (CA)

(21) Appl. No.: 13/119,698

(22) PCT Filed: Sep. 18, 2009
(86) PCT No.: PCT/CA2009/001315

§ 371 Date: May 20, 2011

Related U.S. Application Data
(60) Provisional application No. 61/098,263, filed on Sep. 19, 2008.

(51) Int. Cl. G06F 7/00

(52) U.S. Cl. 701/16

(57) ABSTRACT

A method for determining a hard-landing occurrence for an aircraft has sensors at selected positions of the aircraft. A model defining critical points throughout the aircraft is obtained. Data is received from the sensors when the aircraft lands. Diagnosis values for all critical points of the aircraft are calculated by applying the model to the data from the sensors. The diagnosis values are compared to threshold values for the critical points of the aircraft. A hard-landing occurrence is determined from the comparison between the diagnosis value and the threshold value. A hard-landing occurrence determination system for an aircraft is also provided. Sensors at selected positions of the aircraft provide data related to accelerations at landing of the aircraft. A diagnosis processor unit determines the hard-landing occurrence, and comprises a model database, a threshold database and a threshold comparator. A hard-landing occurrence interface signals a hard-landing occurrence.

### CROSS-REFERENCE TO RELATED APPLICATION

This patent application claims priority on U.S. Provisional Patent Application No. 61/098,263, filed on Sep. 19, 2008

### FIELD OF THE APPLICATION

The present application is related to a method and systems of devices and algorithms dependent on the configuration of the flight equipment to provide information regarding the landing conditions of the aircraft to determine the occurrence of a hard landing and to assess a condition of the equipment.

### BACKGROUND OF THE ART

The landing phase is considered to be one of the most crucial phases of a flight, and the main cause of flight accidents in the past decades. According to some published statistics, a major portion of non-fatal flight accidents occur in the landing phase. Other investigations confirm that, for a typical fleet of aircraft, landing normally has the highest percentage of accidents and/or incidents and, therefore, is considered as the most crucial and risky phase of a mission.

Contributors to accidents could be categorized into two different sets. The first set is related to sensing errors, either human or sensor errors, such as altitude estimate errors, runway conditions, and orientations. The second is due to sudden changes in atmospheric conditions. Gust and wind-shear conditions are responsible for a high number of hard landings and accidents each year.

The multidimensional set of conditions influencing impact includes speed of descent, attitude, weight, instantaneous accelerations, and position of aircraft during landing. This translates into a multidimensional envelope of stresses on different components of both landing gears and airframe.

If mechanical stresses on any given component on the landing gears and/or the airframe exceed allowable values, the aircraft is deemed to have experienced a “hard landing” and must immediately be taken out of service for additional inspection and potential parts replacement.

A hard-landing determination is generally based on a pilot's perception and his/her judgment on whether a hard landing could have caused potential damage to the aircraft structure. However, realization of hard landing based only on the personal opinion of the pilot is not optimally reliable.

The impact at the time of the landing is very brief and, furthermore, it is filtered by the seat and by the body of the pilot, who is quantifying the received acceleration. In effect, the accelerations perceived at the level of the flight deck falsely convey the real load level applied to the aircraft as a whole.

In other words, accelerations felt by a pilot during hard landing are often less than the values which the structure of the aircraft can withstand without damage. Once hard landing is reported by the pilot, a significant number of inspections, perhaps not technically justified, are invoked by the pilot, which entails a waste of time and superfluous expense, heavily penalizing the airline.

Subjective assessment by the pilot still plays an important role in detection of hard landing.

The technical literature regarding methods for determining hard landing can be divided into different classes. A first and often cited method is to utilize kinetic measurements (acceleration, velocity or displacement indications). Another method is to utilize shock-absorber force measurements (pressure or strut bottoming indications). Yet another method is directed to structural-damage detection (fiber optics, wires and conductive paints, acoustic sensors). The last method is capable of providing accurate indications of the structural damage in general and in particular due to hard landing. However, the implementation of the instrumentation in this method poses a challenge to the airframe manufacturers, apart from the large additional mass of the system.

### SUMMARY OF THE APPLICATION

It is an aim of the present disclosure to provide a novel system and method for determining hard-landing occurrence for an aircraft.

In accordance with a first embodiment of the present application, there is provided a method for determining a hard-landing occurrence for an aircraft having sensors at selected positions of the aircraft, comprising: obtaining a model defining critical points throughout the aircraft; receiving data from at least some of said sensors when the aircraft lands; calculating diagnosis values for all said critical points of the aircraft by applying the model to the data from the sensors; comparing the diagnosis values to threshold values for the critical points of the aircraft; and determining a hard-landing occurrence from the comparison between the diagnosis value and the threshold value.

Further in accordance with the first embodiment, the method comprises: comparing the data from the sensors to the diagnosis values at some of the selected locations to identify errors; and creating a refined model with the errors; whereby the refined model is used in subsequent landings to calculate the diagnosis values.

Still further in accordance with the first embodiment, comparing the data from the sensors to the diagnosis values and creating a refined model comprises using a neural network.

Still further in accordance with the first embodiment, the method comprises identifying a load case from the data received from at least some of said sensors when the aircraft lands, and providing threshold values associated to the identified load case for comparing the diagnosis values to the threshold values.

Still further in accordance with the first embodiment, the method comprises identifying an aircraft portion subjected to a greater impact from the load case, and applying a hybrid model to the data from the sensors to calculate the diagnosis values with a detailed model for the aircraft portion, and with a simplified model for a remainder of the aircraft portion.

Still further in accordance with the first embodiment, the method comprises adjusting the threshold values as a function of at least one of the calculated diagnosis values and data from the sensors.

Still further in accordance with the first embodiment, calculating the diagnosis values comprises calculating at least one of the acceleration, the stress and energy for all critical locations of the aircraft.

Still further in accordance with the first embodiment, providing a model of critical locations through the plane comprises providing a finite-element model.

In accordance with a second embodiment, there is provided a hard-landing occurrence determination system for an aircraft, comprising: sensors at selected positions of the aircraft for providing data related to accelerations at landing of the aircraft; a diagnosis processor unit for determining the hard-landing occurrence comprising a model database for providing a model defining critical points throughout the aircraft, a threshold database for providing threshold values for the critical points of the aircraft, diagnosis value calculator for calculating diagnosis values for all said critical points of the aircraft by applying the model to the data from the sensors, threshold comparator for comparing the diagnosis values to the threshold values for the critical points of the aircraft, whereby the diagnosis processor unit determines a hard-landing occurrence from the comparison; a hard-landing occurrence interface for signaling a hard-landing occurrence.

Further in accordance with the second embodiment, the hard-landing occurrence determination system comprises a model refiner for comparing the data from the sensors to the diagnosis values at some of the selected locations to identify errors; and for creating a refined model with the errors for the model database, whereby the refined model is used in subsequent landings to calculate the diagnosis values.

Still further in accordance with the second embodiment, the model refiner comprises a neural network.

Still further in accordance with the second embodiment, the hard-landing occurrence determination system comprises: a load case database storing load cases for the models of the aircraft; and a case identifier for identifying a load case from the data received from at least some of said sensors when the aircraft lands, and for obtaining threshold values associated to the identified load case for comparing the diagnosis values to the threshold values.

Still further in accordance with the second embodiment, the case identifier identifies an aircraft portion subjected to a greater impact from the load case, and the diagnosis value calculator applies a hybrid model to the data from the sensors to calculate the diagnosis values with a detailed model for the aircraft portion, and with a simplified model for a remainder of the aircraft portion.

Still further in accordance with the second embodiment, the diagnosis processor unit adjusts the threshold values as a function of at least one of the calculated diagnosis values and data from the sensors.

Still further in accordance with the second embodiment, the sensors are accelerometers positioned in the landing gear, the fuselage and the wings of the aircraft.

Still further in accordance with the second embodiment, the diagnosis value calculator calculates the at least one of the acceleration, the stress and energy for all critical locations of the aircraft as the diagnosis values.

### BRIEF DESCRIPTION OF THE DRAWINGS

FIG. 1 is a block diagram of a hard-landing occurrence determination system in accordance with an embodiment of the present disclosure;

FIG. 2 is a method for determining a hard-landing occurrence for an aircraft in accordance with another embodiment of the present disclosure;

FIG. 3 is a schematic view of a model with sensors for the system and method of the present disclosure;

FIGS. 4A and 4B are schematic illustrations of different models used with the system and method of the present disclosure;

FIG. 5 is a schematic view of model refiner components of the system of FIG. 1;

FIG. 6 is a schematic view of case identifier components of the system of FIG. 1 with respect to the aircraft;

FIG. 7 is a schematic view of a hard-landing report as produced by the system and method of the present disclosure; and

FIG. 8 is a schematic view of components of the case identifier of FIG. 6.

### DESCRIPTION OF THE PREFERRED EMBODIMENTS

The energy transmitted to the structure during landing can be effectively used to detect the integrity of the structure of the aircraft.

The present disclosure pertains to an embodiment enabling more detailed and improved evaluation of an aircraft's landing condition monitoring through focusing away from the conditions and attitude of aircraft (sink speed, roll angle, yaw angle, etc.). A hard-landing occurrence determination system performs a detailed analysis of impact energy, initiating from landing gears and traveling through the airframe, to determine whether an aircraft has experienced a hard landing that exceeds the allowable design loads of the aircraft in the landing phase of a flight. Moreover, if hard landing occurs, specific components may experience an overload. An aircraft experiences a multidimensional set of input parameters in the landing operation either controlled by the pilot or affected by environmental variables such as gust loads and runway conditions.

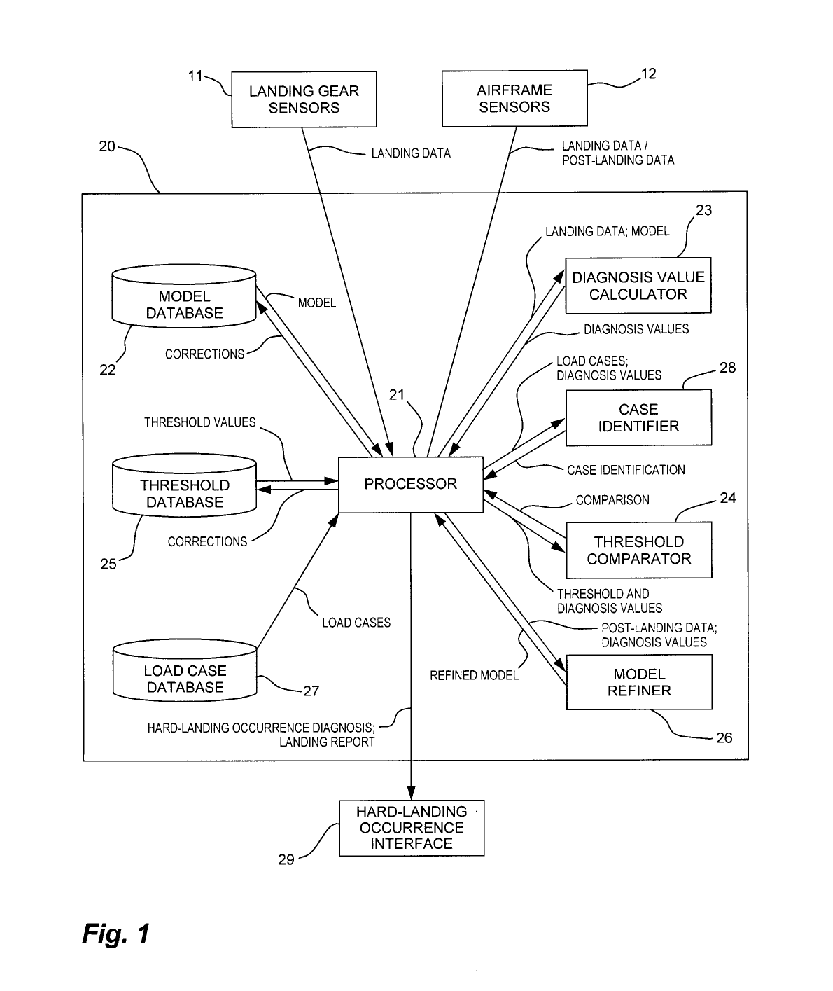

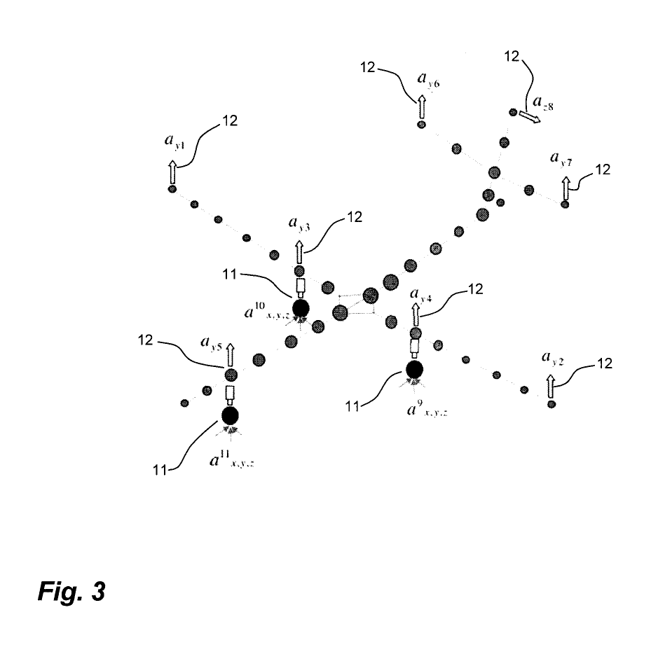

Referring concurrently to FIGS. 1 and 3, a hard-landing occurrence determination system is generally shown at 10. The system 10 has landing-gear sensors 11. The landing-gear sensors 11 are inertial sensors, such as accelerometers or any other appropriate or equivalent types of sensors, that collect data when the aircraft effects a landing.

Referring to FIG. 1, the system 10 also has airframe sensors 12, positioned throughout the airframe, such as at selected positions in the fuselage and in the wings of the aircraft. For instance, there is illustrated in FIG. 3 an aircraft with the sensors 11 and 12 at eleven positions. There may be more or less of the sensors.

Vertical accelerations or like data being read by the landing-gear sensors 11 are used by a model for each landing gear, to approximate the impact level generated by the tires and damped by the shock absorbers. The governing equations are explained in detail hereinafter.

The system 10 has a diagnosis processing unit 20. The diagnosis processing unit 20 receives data from the sensors 11 and 12, and determines whether a hard landing has occurred at landing. The processing unit 20 features a processor 21 (e.g., computer, micro-controller, etc) for performing the operations of the system 10.

The processing unit 20 applies a model of the aircraft to the data received from the sensors upon the landing of an aircraft, and more specifically, the landing-gear sensors 11, so as to calculate diagnosis values for critical points preferably on the entirety of the aircraft, i.e., the fuselage and wings. Therefore, as described hereinafter, the model used by the processing unit 20 defines a plurality of critical points of the aircraft. Accordingly, the processing unit 20 has a model database 22 for storing parameters of models of the aircraft, as well as parameters of refined models.

A diagnosis value calculator 23 calculates diagnosis values for the aircraft. The diagnosis values may be any of acceleration values, force values, stress values, deformation values or the like, in any suitable form, as detailed hereinafter. The diagnosis value calculator 23 applies the model of the aircraft received from the model database 22 to the data from the landing-gear sensors 11, so as to obtain these diagnosis values for the critical points of the model. Preferably, the diagnosis values cover the aircraft in its entirety. Depending on the model used, some parts of the aircraft may comprise more critical points, by the use of models comprising hybrid submodels (e.g., a detailed finite-element model for a wing, stick model for a remainder of the aircraft), as a function of a landing case.

Still referring to FIG. 1, a threshold comparator 24 compares the diagnosis values calculated by the diagnosis value calculator 23 with corresponding threshold values for the critical points of the aircraft. The threshold values are received from a threshold database 25, and represent acceptable parameters for the critical points of the aircraft (e.g., in terms of acceleration, deflection, stresses). The threshold values from the database 25 may be corrected so as to take into account factors such as fatigue over the life of the aircraft. Accordingly, the corrections of the threshold values over time allow the system 10 to take into account the cumulative effect of landing cycles on the components of the aircrafts (e.g., at the critical points).

The processor 21 receives the comparison from the threshold comparator 24, and determines whether the landing is a hard landing. For instance, if any of the diagnosis values exceeds the corresponding threshold value, the landing may be qualified as a hard landing.

With regard to the model parameters received from the model database 22 and used by the diagnosis value calculator 23, a finite-element model may be generated targeting only the estimation of the landing loads and not considering the attitude of aircraft or other existing parameters, such as gust loads.

Through the landing data pertaining to landing loads, the level of load increase in the aircraft's components and subsystems is calculated. A finite-element model is able to estimate the accelerations on any point of the airframe or landing gears and also flexural and shear loads in these components.

However, to accelerate processing of the data to perform real-time diagnosis of hard-landing occurrence, simplifications of the model may be used, such as finite-element and lumped-mass method may introduce simplification errors in the system.

Changes in the aircraft's structural properties cause errors over time. The cause of these changes may be structural fatigue or gradual plastic deformations occurring in the structure. If these errors are not minimized to an acceptable window of tolerance, the results are not reliable enough for hard-landing detection. Accordingly, the threshold database may correct the threshold values in view of the changes in structural properties, to take into account the cumulative effect of numerous landings.

Referring to FIG. 3, three landing-gear sensors 11 and eight structural sensors 12 are illustrated at selected positions on the aircraft, along with their designated directions of sensing, to provide one example. The data signals provided by the sensors 11 and 12 are filtered and used for diagnosis value calculation and model refinement. The sensors 12, for instance, may be used as reference criteria with which the diagnosis values for the selected positions are compared by a model refiner 26, to calculate errors. These errors are used by the model refiner 26 to refine the model for subsequent landing diagnosis, with the refined model being stored in the model database 22.

More specifically, by comparing acceleration (aₛ) being read from the sensors 12 and ones calculated from the model (a_{g}) by the calculator 23, an array of errors is generated. The model refiner 26 may have a neural-network algorithm responsible for generating series of weighting factors (Wᵢ). Neural networks are composed of simple elements operating in parallel. It is possible to train a neural network to perform a particular function by adjusting the values of the connections (weights) between elements.

The diagnosis values may be composed of forces, moments and deflections. A post-processing step is by the model refiner 26 on the data from the sensors 11 and/or 12 to generate engineering results such as mechanical stress or strain results, and also landing gear's shock-absorber strokes. Based on the calculated forces and strokes, energy equations may also be formed to estimate the landing-gear energy dissipation rate. While the landing gear is being monitored for any overloads in vertical, side and draft directions, an energy comparison method serves as a validating algorithm comparing variables with energy thresholds for different load cases. As an example, these thresholds may be defined by the manufacturer. The amount of energy dissipated by shock absorbers of main or central landing gears should be equal to the combined kinetic and potential energy of the aircraft at the point of touchdown for the designed descending speed.

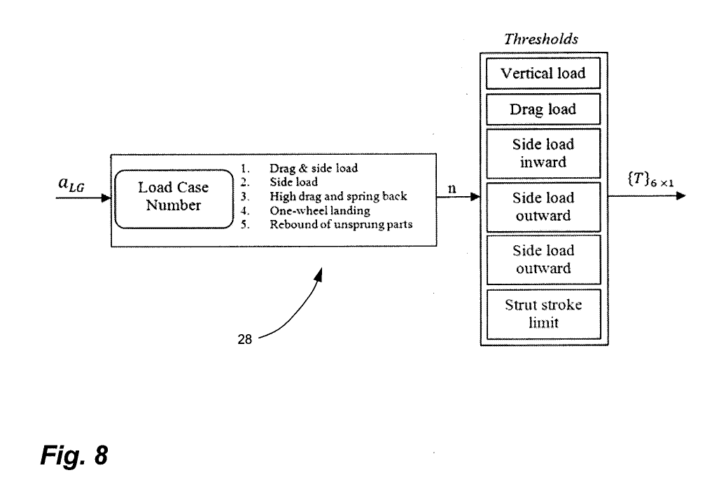

According to FIG. 8, different landing load cases will result in different allowable loads and allowable shock-absorber closure. The landing load case is selected from the case database 27 by a case identifier 28, by comparing landing-gear sensor data at the point of touchdown to landing load cases.

The case identifier 28 may perform filtering with certain cut-off frequencies on the sensor data and thus compares spikes in a defined bandwidth. One of the benefits of using accelerometers for the landing-gear sensors 11 is that they can detect abnormal conditions milliseconds after impact.

Therefore, in real-time applications, the case identifier 28 identifies the landing load case immediately after touchdown, setting the threshold values 12, before threshold comparison by the threshold comparator 24, and thus before loads and energies reach their peak values. Moreover, a landing load case may identify that a given portion of the aircraft may be subjected to a greater impact than other parts of the aircraft. Accordingly, the model may be selected so as to obtain more critical points at the given portion of the aircraft, with a more detailed finite-element model, while a remainder of the aircraft uses a simplified model (e.g., stick model).

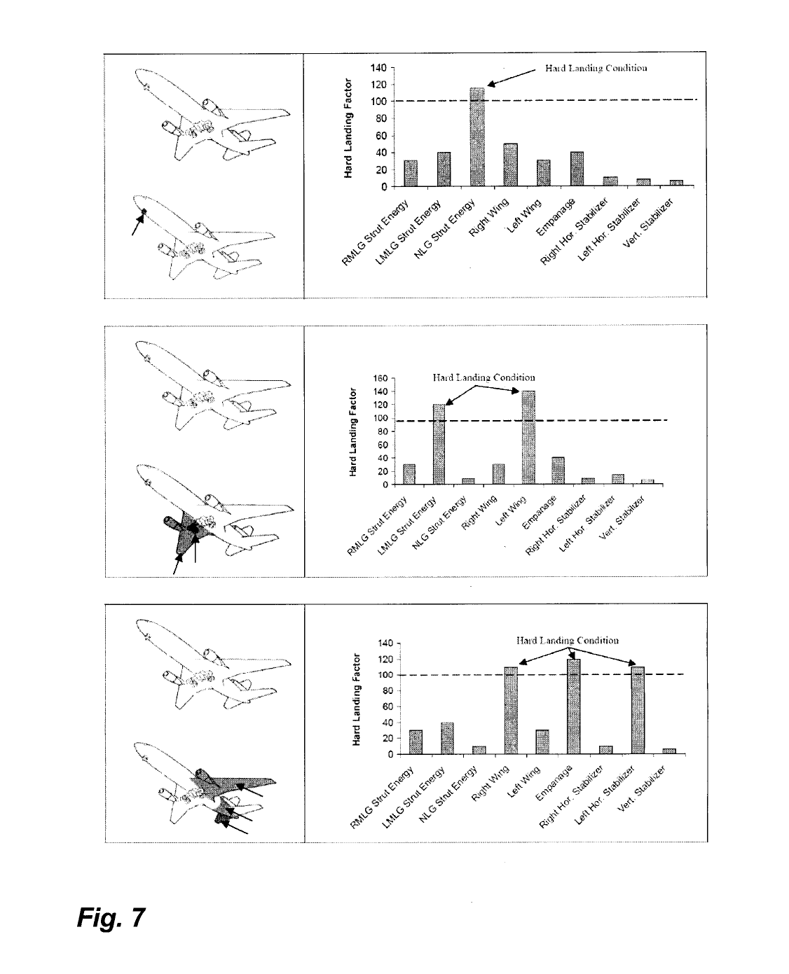

The hard-landing occurrence interface 29 signals hard landing occurrences, and provides landing reports, such as the one illustrated in FIG. 7. The hard-landing occurrence interface 29 may be any of a monitor, an output port, a data file, a printer or any other suitable interface.

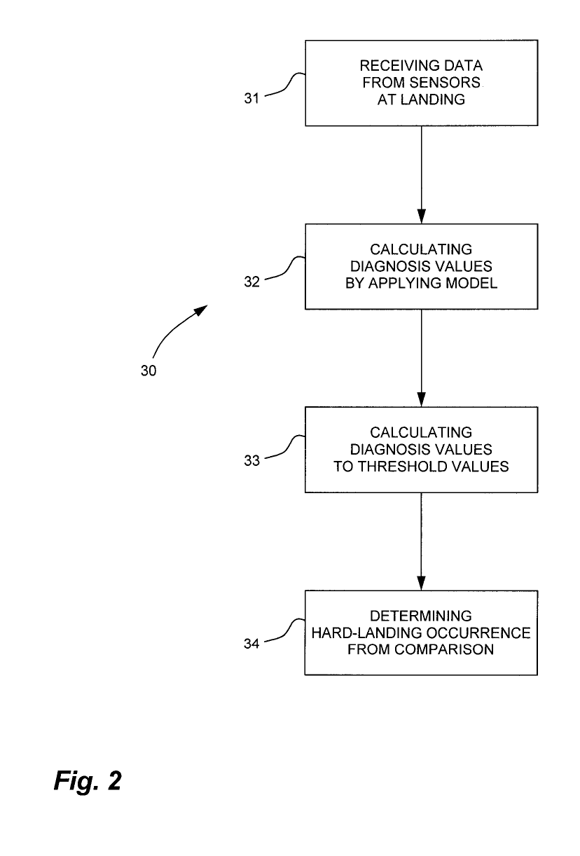

Now that the various components of the system have been described, a general method is set forth, as illustrated at 30 in FIG. 2.

According to 31, data is received from at least some of said sensors 11 and/or 12 when the aircraft lands.

According to 32, diagnosis values are calculated by the diagnosis value calculator 23 for critical points of the aircraft by applying the model to the data from the sensors 11/12, the model being obtained from the model database 22.

According to 33, the diagnosis values are compared to threshold values by the threshold comparator 24, for the critical points of the aircraft. The threshold values are obtained from the threshold database 25.

According to 34, a hard-landing occurrence is determined from the comparison between the diagnosis value and the threshold value, by the processing unit 20. The occurrence is signaled by the interface 29.

The method may also use the model refiner 26 to compare the data from the sensors to the diagnosis values at some of the selected locations to identify errors, and thus to create a refined model with the errors for use in subsequent landings to calculate the diagnosis values. The method may identify with the case identifier 28 a load case from the data received from at least some of said sensors when the aircraft lands, and provide threshold values (from the threshold database 25) associated to the identified load case for comparing the diagnosis values to the threshold values. The load cases are provided by the load case database 27.

The method may also adjust the threshold values with the processor unit 20 as a function of at least one of the calculated diagnosis values and data from the sensors.

The system 10 shown in FIG. 1 records estimated loads, energies and shock-strut closure from the sensors 11 and/or 12. This data is compared with predetermined thresholds as described above, and generates a set of scale parameters quantifying the landing by the threshold comparator 24. The processor 21 sets a hard-landing flag if any of these parameters exceed their threshold. These threshold values are individually determined for each type of landing gear or airframe.

The model used in the diagnosis quantifies the landing operation into series of dimensionless-state variables, and is therefore practical for landing-assisted control systems. The results provided by the threshold comparator 24 may be sent to aircraft control systems. These control systems are categorized into auto-landing systems controlling the aircraft dynamics before touchdown and also the ones which control after-landing state variables such as active/semi-active control of shock absorbers.

Statistical analysis of the collected landing loads and stresses over operational life of an aircraft reveals another application, namely the fatigue life estimation of main components of the aircraft. Although they are limited only to ground loads, these loads and deformations can provide insight into the life estimation of parts in the vicinity of landing gears and wing-fuselage attachments. The processor 21 may record the statistical data, or output same through the input interface 29.

In real-time applications, representation of a full aircraft model which represents dynamics and flexibility of all components may not be achievable due to processing limitations of the processor 21. Therefore, approximation techniques may be utilized to estimate the behavior of the structure under impact loads. One known approximation technique consists in the use of a finite-element model known as “stick model” to simplify the aircraft structure. Stick models may be used for dynamic or mode-shape analysis of aircraft. A stick model is a beam model that may comprise force and deflection information.

There are different finite-element methods that can be used to analyze vibration behavior of beam structures. Among them, a “lumped matrix” formulation has some appropriate properties. It may be easy to associate a lumped matrix formulation with a physical model, to provide a diagonal matrix. After assemblage of elements, the structural-mass matrix is therefore also diagonal. This leads to significantly fewer computations and fewer computer storage requirements.

This method has different formulations compared to the conventional beam-vibration formulation. The mass and damping distributions are formulated using the lumped method resulting in equation (1):

{F}_{12×1}=[K]_{12×12}·{u}_{12×1} (1)

Here, the term {F}_{12×1} represents beam equivalent forces and moments at nodes of each element. {u}_{12×1} is degrees of freedom at each node in space.

Finally, the equation of motion for a single element is formulated according to equation (2). In this equation, stiffness properties of elements are added up with rigid motion of mass at element nodes. m is the lumped-mass matrix, c is the damping, with both m and c being diagonal. k is the stiffness matrix and is non-diagonal.

[m]{ü}+[c]{ [symbol] }+[k]{u}={F} (2)

The above equations of the beams are coupled with those of each landing gear resulting in the reference model to be used by the diagnosis value calculator 23 (FIG. 1). The aircraft's stick model is positioned without considering the attitude angles or initial velocities. It is an example of a testing platform examining the impact energy on the structure. Loads are estimated by accelerations sensed on the landing gears based on the type of landing gear used for the aircraft.

After merging airframe matrices along with landing-gear dynamic equations, the formulation results in ordinary differential equations which are solved using numerical methods by the diagnosis value calculator 23. By solving the system of equations, all deformations and slopes at each node in the structure may be calculated as the diagnosis values. In addition, velocities and accelerations of all critical points on landing gears and airframe may be available at each time step.

Referring to FIG. 3, an embodiment is illustrated in which, eleven positions on the airframe and landing gears are selected for attachment of micro-accelerometers, as sensors 11 and 12. The location of these selected positions is based on the level of sensitivity and compatibility with the mathematical formulation. The positions are selected in such a way that it may be possible to monitor vibration behavior of each subsystem (landing gears, wings, fuselage, etc.). A direction of sensing is also illustrated in FIG. 3.

After assembling the finite-element and lumped-mass models, another mathematical procedure may be done to confirm the results. Eigenvalues and eigenvectors are found by solving equation (3) for ω, which correspond to natural frequencies for different mode shapes.

det([k]−[m]ω²)=0 (3)

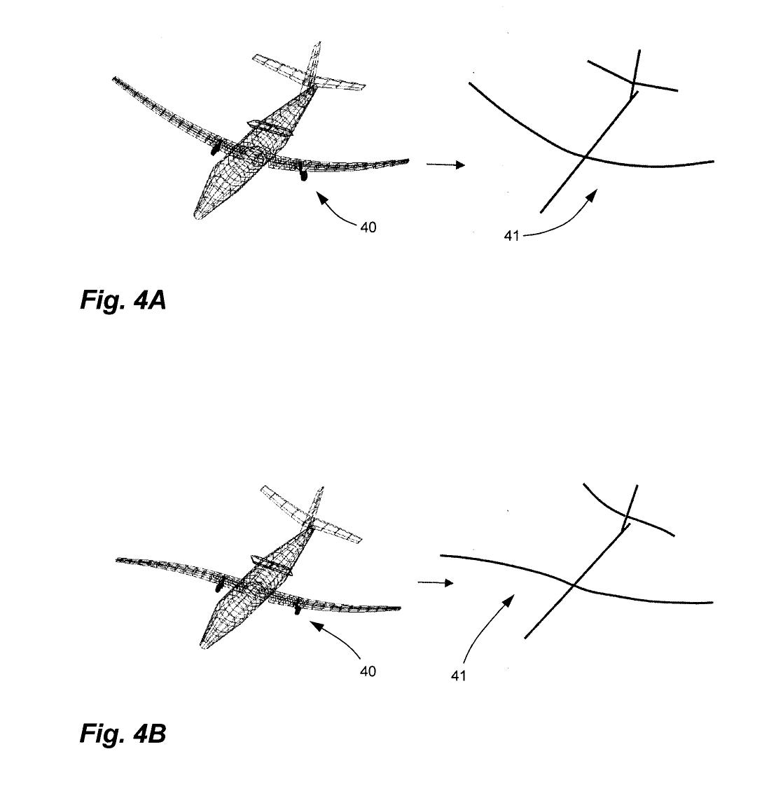

It is considered to use models from manufacturers. More specifically, aircraft manufacturers generate elaborate models to find mode shapes of their aircraft, for instance as one of the procedures of design of an aircraft. These models provide reliable natural frequencies of the aircraft. It is desired to minimize the difference between those related natural frequencies and the ones solved by equation (3) for the proposed stick model. The term “related natural frequencies” is used to denote that all mode shapes found by the stick model do not correspond to a real aircraft. For instance, the stick model describe above may not be unable to extract twist deformation of the wing, simply because, in landing, torsion of the wing is not significant compared to bending modes. This is schematically shown in FIGS. 4A and 4B for two mode shapes, with an elaborate model shown at 40 and the stick model shown at 41.

Special attention must be paid to modeling and assembling of different elements. For example, according to FIG. 3, the connection of the right and left wings to the fuselage cannot happen in one point, as this may cause a large concentrated load causing erroneous results. Also, location of sensors 11 and 12 should be selected purposefully. Locations such as tip of the wings, in which acceleration amplitudes are higher and frequencies are lower, may be more convenient. Higher frequencies in the wing (generally higher than 50 Hz) correspond to local mode shapes for components such as stringers or ribs which are not considered in the stick model.

Since the reference model is a simplified representation of the real aircraft's structure, a neural network system may be used as part of the model refiner 26 (FIG. 1) to ensure the reliability of the model.

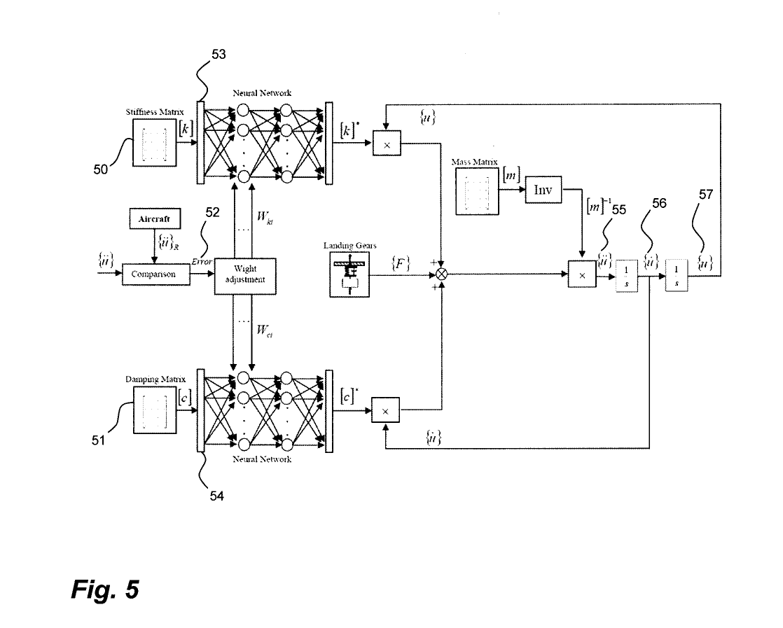

According to FIG. 5, stiffness 50 and damping 51 matrices for each element, and also parameters corresponding to landing loads, are multiplied by series of weighting factors controlled by neural networks. These factors are constantly changing so that response error 52 (Error≡{ü_{R}}−{ü}) is minimized. The neural networks 53, 54 are two-layer feed-forward neural networks with the back propagation. After tuning matrices, ordinary differential equations may be solved to find accelerations 55, velocities 56 and/or deflections 57 for that time step. This way, the reference model is constantly refining itself into a refined model, allowing the model to adjust over time to a gradual increase of plastic deformations in the aircraft. The accuracy of the model will increase as landings are experienced, because of the model refiner 26. This results from the attractive “learning” capabilities of neural network systems, according one embodiment.

Referring back to FIG. 1, after calculating the diagnosis values for instance by solving accelerations, velocities and/or deflections for the critical points, series of post-processing procedures may be performed to find the relative stresses in each airframe or landing-gear element. Also, it is possible to find the stroke and velocity of closure of shock absorbers and perform an energy analysis based on the specifications provided by the landing-gear manufacturer.

The acceleration signals being read by accelerometers attached to landing gears and airframe may pass several filters to be suitable for comparison to the ones solved by the reference model. According to the eigenvalue analysis mentioned earlier, bandwidth of the required frequencies is known. This bandwidth is different for different classes of aircraft, and is provided by the manufacturer.

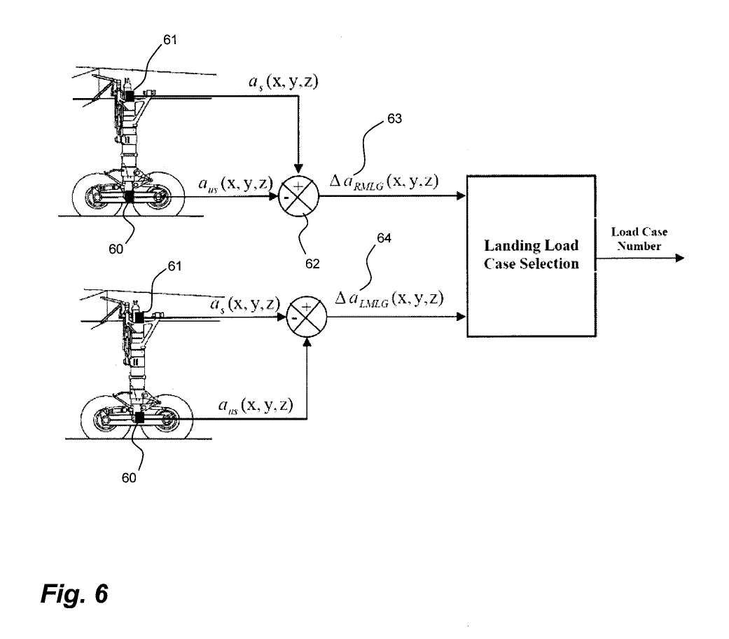

For real-time applications, the case identifier 28 may be used to simplify processing of data by the processor unit 20. As shown in FIG. 6, using sensors such as two accelerometers attached to wheels or boggie beams 60 and another on the uppermost point on the shock absorbers cylinder 61, with the sensors measuring accelerations in local reference frame for three directions and subtracting these values 62, it is possible to find the shock absorbers deformation accelerations 63, 64. This deformation acceleration will spike at the moment of touchdown.

By comparing these maximums, the case identifier 28 is able to find the condition of landing immediately after touchdown using load cases from the load case database 27, providing enough time to the system to set the threshold values based on the load case before loads reach their peak value. This deformation acceleration spike happens in a fraction of seconds, whereby appropriate sensor's sensitivity and bandwidth of filter should be used. The threshold comparator 24 subsequently uses the selected thresholds to perform the comparison with the diagnosis values.

A hard-landing occurrence diagnosis processing unit 20 performs a health monitoring on the airframe and landing gears based on the results of the models. The diagnosis may be performed according to various steps.

For instance, after diagnosis values pertaining to stresses in the airframe and landing-gear dissipated energies in each time interval, these values are divided by their thresholds addressed by the load case number, as provided by the case identifier 28. Referring to FIG. 7, an array of dimensional parameters called hard-landing factor (HLF) is calculated. Each HLF corresponds to a single subsystem in the aircraft, quantifying the level of impact loads.

Stress levels in the structure and landing-gear attachment points to the wing or fuselage in landing operation may be recorded. After each landing, series of statistical analyses are performed on all previous landing stresses. Two types of valuable analysis can be done. A first analysis is the fatigue analysis using S-N curves (provided by the manufacturer). These S-N curves can point out the remaining fatigue life of each part base on the load cycles and level of experienced stresses. A second analysis provided by this algorithm is the probability analysis of stresses experienced by the aircraft in previous landings. The probability of an event is the number of ways an event can occur divided by the total number of possible outcomes. For example, after two years of operation for an aircraft, it is possible to find out how many times certain stress levels were exceeded. This information may be used to update the threshold values in the threshold database 25, for subsequent diagnoses.

With the sensors 11 and 12 attached to selected positions on the structure, the data from the sensors 11 and/or 12 is used by the model refiner 26 to monitor the reliability of model results. In the case of existence of an error between diagnosis values calculated by the diagnosis value calculator 23 and the real values from the data of the sensors by the model refiner 26, series of weighting factors are tuned by the model refiner 26 to correct the response of the model. However, the mathematical representation of the aircraft is linear. Accordingly, in the case of sudden high-amplitude impact loads leading to nonlinear deformations, the linear model will still try to change the weighting factors to comply its response with the real aircraft response.

This model refiner 26 is responsible for monitoring these errors. If the amount of error is more than a certain level, a plastic deformation detection system may be triggered. It has been observed that “major structural failures” have a signature that can be traced by frequency-domain analysis of responses. Plastic deformation of structures consumes a large amount of energy. This sudden energy release is sensed by the accelerometers attached to the same subsystem and, when compared with the linear model responses, it provides an interesting result for judging whether or not a part is critically damaged.

Finally, after all these mathematical operations, which are still performed in real time, the processor 21 will decide on the health of aircraft subsystems and, in the case of abnormal stress or energy levels, it flags a hard-landing occurrence and provides the maintenance team with a report giving a complete insight into the degree of hand landing, possible damaged subsystems and/or their previously experienced stress or energy levels, suing the output interface 29. An example of such a report is illustrated in FIG. 7.

1. A method for determining a hard-landing occurrence for an aircraft having sensors at selected positions of the aircraft, comprising:
obtaining a model defining critical points throughout the aircraft;
receiving data from at least some of said sensors when the aircraft lands;
calculating diagnosis values for all said critical points of the aircraft by applying the model to the data from the sensors;
comparing the diagnosis values to threshold values for the critical points of the aircraft; and
determining a hard-landing occurrence from the comparison between the diagnosis value and the threshold value.

2. The method of claim 1, further comprising:
comparing the data from the sensors to the diagnosis values at some of the selected locations to identify errors; and
creating a refined model with the errors;
whereby the refined model is used in subsequent landings to calculate the diagnosis values.

3. The method according to claim 2, wherein comparing the data from the sensors to the diagnosis values and creating a refined model comprises using a neural network.

4. The method according to claim 1, further comprising identifying a load case from the data received from at least some of said sensors when the aircraft lands, and providing threshold values associated to the identified load case for comparing the diagnosis values to the threshold values.

5. The method according to claim 4, further comprising identifying an aircraft portion subjected to a greater impact from the load case, and applying a hybrid model to the data from the sensors to calculate the diagnosis values with a detailed model for the aircraft portion, and with a simplified model for a remainder of the aircraft portion.

6. The method according to claim 1, further comprising adjusting the threshold values as a function of at least one of the calculated diagnosis values and data from the sensors.

7. The method according to claim 1, wherein calculating the diagnosis values comprises calculating at least one of the acceleration, the stress and energy for all critical locations of the aircraft.

8. The method according to claim 1, wherein providing a model of critical locations through the plane comprises providing a finite-element model.

9. A hard-landing occurrence determination system for an aircraft, comprising:
sensors at selected positions of the aircraft for providing data related to accelerations at landing of the aircraft;
a diagnosis processor unit for determining the hard-landing occurrence comprising:
a model database for providing a model defining critical points throughout the aircraft;
a threshold database for providing threshold values for the critical points of the aircraft;
diagnosis value calculator for calculating diagnosis values for all said critical points of the aircraft by applying the model to the data from the sensors;
threshold comparator for comparing the diagnosis values to the threshold values for the critical points of the aircraft, whereby the diagnosis processor unit determines a hard-landing occurrence from the comparison;
a hard-landing occurrence interface for signaling a hard-landing occurrence.

10. The hard-landing occurrence determination system according to claim 9, further comprising a model refiner for comparing the data from the sensors to the diagnosis values at some of the selected locations to identify errors; and for creating a refined model with the errors for the model database, whereby the refined model is used in subsequent landings to calculate the diagnosis values.

11. The hard-landing occurrence determination system according to claim 10, wherein the model refiner comprises a neural network.

12. The hard-landing occurrence determination system according to claim 9, further comprising:
a load case database storing load cases for the models of the aircraft; and
a case identifier for identifying a load case from the data received from at least some of said sensors when the aircraft lands, and for obtaining threshold values associated to the identified load case for comparing the diagnosis values to the threshold values.

13. The hard-landing occurrence determination system according to claim 12, wherein the case identifier identifies an aircraft portion subjected to a greater impact from the load case, and the diagnosis value calculator applies a hybrid model to the data from the sensors to calculate the diagnosis values with a detailed model for the aircraft portion, and with a simplified model for a remainder of the aircraft portion.

14. The hard-landing occurrence determination system according to claim 9, wherein the diagnosis processor unit adjusts the threshold values as a function of at least one of the calculated diagnosis values and data from the sensors.

15. The hard-landing occurrence determination system according to claim 9, wherein the sensors are accelerometers positioned in the landing gear, the fuselage and the wings of the aircraft.

16. The hard-landing occurrence determination system according to claim 15, wherein the diagnosis value calculator calculates at least one of the acceleration, the stress and energy for all critical locations of the aircraft as the diagnosis values.
